(19) United States
(12) Patent Application Publication
(10) Pub. No.: US 2018/0001558 A1
(43) Pub. Date: Jan. 4, 2018

(54) A MACHINE FOR 3D OBJECTS MANUFACTURE

(71) Applicant: MASSIVIT 3D PRINTING TECHNOLOGIES LTD., Lod (IL)

(72) Inventors: Itzhak Taff, Yavne (IL); Ido De La Vega, Tel Aviv (IL)

(73) Assignee: MASSIVIT 3D PRINTING TECHNOLOGIES LTD., Lod (IL)

(21) Appl. No.: 15/545,678

(22) PCT Filed: Feb. 9, 2016
(86) PCT No.: PCT/IL2016/050147

§ 371 Date: Jul. 22, 2017

Related U.S. Application Data
(60) Provisional application No. 62/132,029, filed on Mar. 12, 2015.

(51) Int. Cl. B29C 64/209; B33Y 30/00; B29C 64/106; B29C 64/118; B29K 75/00; B33Y 10/00; B29C 64/129

(52) U.S. Cl. CPC B29C 64/209; B29C 64/106; B33Y 30/00; B29C 64/118; B33Y 10/00; B29C 64/129; B29K 2075/02

(57) ABSTRACT

Described is a high throughput machine for manufacture of large size 3D objects. The machine uses a combination of a large size main material dispensing head with a satellite lightweight material dispensing head. A motion system could move each material dispensing head along a path identical to the other dispensing head path or move it along a path different from the path of the other material dispensing head. Such complementary movement supports increase in machine throughput.

### TECHNOLOGY FIELD

The machine and the method relate to 3D objects manufacturing technologies and in particular to high throughput machines.

### BACKGROUND

Printing of three-dimensional (3D) objects is a fast developing industry. The term “printing” includes a variety of additive manufacturing (AM) processes to create a three-dimensional object. In additive processes the 3D object is produced by successive dispensing of layers of material laid down on top or bottom of previously deposited layer. The 3D objects can be manufactured of almost any shape or geometry. The objects are produced from a computer generated 3D model and the equipment producing a 3D object is usually computer controlled.

3D objects are created by different additive processes such as inkjet printing, filament extrusion, powder sintering and others. The materials used for the 3D objects creation could be dispensed in liquid form and hardened by actinic radiation. Extruded or sintered materials do not require hardening by actinic radiation.

Additive manufacturing devices usually use a material dispensing or writing head or element to deposit the material in order to construct a solid 3D object. The material dispensing head typically deposits layer after layer, gradually adding object details building the three-dimensional (3D) object representation. A movement system supplies movement in space in three directions, typically, along the X-Y and Z axes. In some machine implementations, the support or platform with the 3D object is moved in the three directions. Machine implementations where the support with the 3D object is moved in two, for example, X and Y direction, and the material dispensing head moves in Z-axis direction exist. Other machine implementations with different split of the movement between the support with the 3D object platform and material dispensing head are known. The larger the 3D object to be created, the larger is the machine and change of material dispensing direction (for example, reciprocate) takes more time since the machine has to overcome inertia generated by the moving support or material dispensing head. This significantly reduces the throughput of the 3D object creation machine.

U.S. Pat. Nos. 4,976,582, 7,331,750, 7,735,390 and 8,456,124 disclose mechanisms where the material dispensing head is suspended on a number of kinematic levers. Change of relative positon of the levers moves the connected to the levers head in all three (X-Y-Z) directions and can position it in any point in space. Such multi-lever mechanisms have been adapted for creation of smaller 3D objects. Printers including such mechanisms are currently termed Delta (A) printers. With the Delta technology, the levers that move the head, which could be a material dispensing head, move in a synchronized simultaneous movement and their movements are complement each other. The movement of the levers is such that regardless the direction they move the material distribution head, the head remains in a plane parallel to the support on which the 3D object to be created is placed. The Delta machines can move the material dispensing head at a speed far exceeding the speed the conventional X-Y axes machines can move.

The Delta printers are mostly extrusion type machines and are designed to dispense material from a filament. The filament is an easily melting and fast-congealing plastic strip that is pulled from a storage reel. Such arrangement decreases the weight of the material dispensing head and does not resist fast movements of the material dispensing head.

### SUMMARY

Increase in throughput of a machine for manufacture of large size 3D objects has been provided by a combination of a large size main material dispensing head with a satellite lightweight material dispensing head. A motion system could move each material dispensing head along a path identical to the other dispensing head path or move it along a path different from the path of the other material dispensing head. Such complementary movement support increase in machine throughput.

The satellite material dispensing head could be configured to dispense material including the point coinciding with the point where the axis of symmetry of the main material dispensing head intersects the plane where the main material dispensing head is depositing the material. The satellite material dispensing head could be configured to support linear movement in X and Y direction. In some examples, the satellite material dispensing head could be configured also to move in direction of Z axis.

In addition to linear movement, the satellite material dispensing head can move in an oscillating type movement along and across the main material dispensing head travel direction and the amplitude and frequency of the oscillating type movement of the satellite materia' dispensing head could be variable.

The motion system of the 3D object manufacturing machine could be configured to move the main material dispensing head and hold in place the satellite material dispensing head and vice versa.

The material that the main material dispensing head and satellite material dispensing head dispense could be gel, plastic filament or other similar materials.

Both the main and satellite material dispensing heads could dispense identical material. Both the main and satellite material dispensing heads could dispense a layer of material of similar or identical thickness or each of the material dispensing heads could deposit a layer of material of different and variable thickness.

The satellite material dispensing head also could dispense a material different in at least one parameter from the material the main material dispensing head dispenses or extrudes.

The machine could include one or more material solidifying energy sources configured to harden or solidify the layer of deposited material. The energy sources could be such as ultraviolet energy sources, heat energy sources, microwave energy sources and others as it could be required to solidify the extruded material. In some examples, where the extruded material is extruded from a filament no solidifying energy is required as the material will cool down and solidify.

### LIST OF DRAWINGS AND THEIR BRIEF DESCRIPTION

FIG. 1 is a schematic illustration of a 3D manufacturing machine according to an example;

FIG. 2 is a schematic illustration of a 3D manufacturing machine according to another example;

FIG. 3 is an example of satellite material dispensing head movement pattern;

FIG. 4 is another example of satellite material dispensing head movement pattern;

FIG. 5 is an example of a 3D object manufactured by both main and satellite material dispensing heads;

FIG. 6 is an example of main and satellite material dispensing head movement pattern;

FIG. 7 is an additional example of main and satellite material dispensing head movement pattern; and

FIG. 8 is a schematic illustration of a 3D manufacturing machine according to still another example.

### DESCRIPTION

Increase in throughput of a machine for manufacture of large size 3D objects could be provided by a combination of a large size main material dispensing head with a satellite lightweight material dispensing head. The motion system could move each material dispensing head along a path identical to the other dispensing head path or move it along a path different from the path of the other material dispensing head increasing the machine throughput.

The satellite material dispensing head could be configured to dispense material including the point coinciding with the point where the axis of symmetry of the main material dispensing head intersects the material deposition plane. The satellite material dispensing head could be configured to follow the main material dispensing head or to support additional linear movement in X and Y direction. in some examples, the satellite material dispensing head could be configured to move in direction of Z axis. In addition to linear movement, the satellite material dispensing head can move in an oscillating type movement along and across the main material dispensing head travel direction and the amplitude and frequency of the oscillating type movement of the satellite material dispensing head could be variable.

In one example, the main material dispensing head is a multilink mechanism similar to satellite material dispensing head attached to a carrier configured to move the main material dispensing head on a distance exceeding span of the multilink mechanism.

The material that the main material dispensing head and satellite material dispensing head dispense could be gel, plastic filament or other similar materials.

Both the main and satellite material dispensing heads could dispense identical material. Both the main and satellite material dispensing heads could dispense a layer of material of similar or identical thickness or each of the material dispensing heads could deposit a layer of material of different and variable thickness.

The satellite material dispensing head also could dispense a material different in at least one parameter from the material the main material dispensing head dispenses or extrudes.

The machine could include one or more material solidifying energy sources configured to harden or solidify the layer of deposited material. The energy sources could be such as ultraviolet energy sources, heat energy sources, microwave energy sources and others as it could be required to solidify the extruded material. In some examples, where the extruded material is extruded from a filament no solidifying energy is required as the material will cool down and solidify.

The satellite material dispensing head can move in an oscillating type movement along and across the main material dispensing head travel direction and the amplitude and frequency of the oscillating type movement of the satellite material dispensing head could be variable.

The motion system of the 3D object manufacturing machine could be configured to move the main material dispensing head and hold in place the satellite material dispensing head and vice versa.

The material that the main material dispensing head and satellite material dispensing head dispense could be gel, filament or other similar materials.

Both the main and satellite material dispensing heads could dispense identical material. Both the main and satellite material dispensing heads could dispense a layer of material of similar or identical thickness or each of the material dispensing heads could deposit a layer of material of different thickness.

The satellite material dispensing head also could dispense a material different in at least one parameter from the material the main material dispensing head dispenses.

The machine could include one or more material solidifying energy sources configured to harden or solidify the layer of deposited material. The energy sources could be such as ultraviolet energy sources, heat energy sources, microwave energy sources and others as it could be required to solidify the extruded material. In some examples, where the extruded material is extruded from a filament no solidifying energy could be required as the material will cool down and solidify.

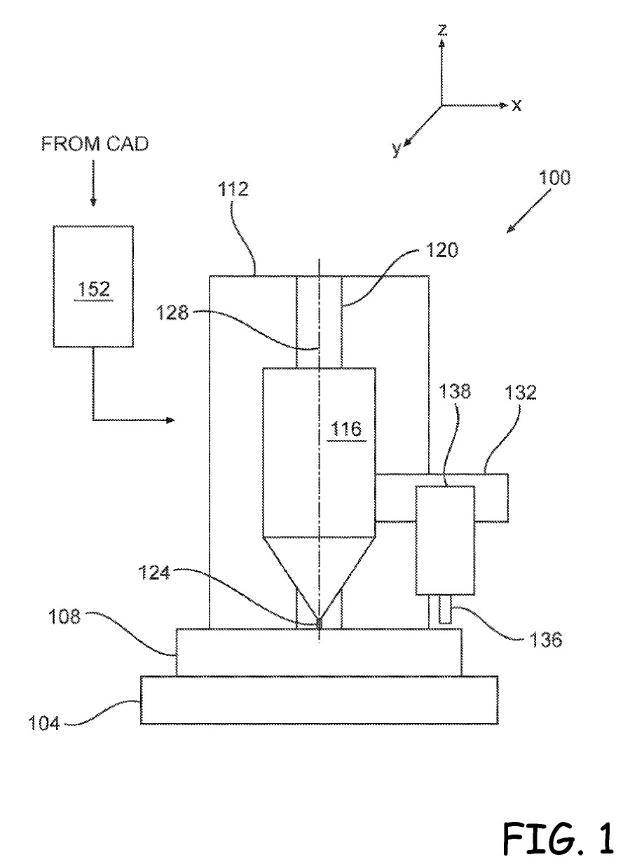

Reference is made to FIG. 1 which is a schematic illustration of a 3D object manufacturing machine according to an example. Machine 100 includes a support 104 configured to support a 3D object 108 to be manufactured. Support 104 could be a static support and also it could move 3D object along the X and Y axes. In some examples, support 104 could optionally move in the direction of Z-axis. Column 112 holds a main material dispensing head 116 and guides 120 on which main material dispensing head 116 could move in the direction of Z-axis. In some examples, main material dispensing head 116 could optionally move in the direction along the X and Y axes.

3D object 108 is manufactured from material 124 dispensed or extruded through nozzle (not shown) of main material dispensing head 116. Material 124 could be such as gel disclosed in European Patent Application EP 15150125.1 to the assignee of the present application or a standard 3D plastic filament commercially available from a number of retail stores, e.g. from MATTERHACKERS, Lake Forest, Calif. 92630 U.S.A., or 3D Filament Manufacturing Company, Canal Fulton, Ohio 44614 U.S.A. Reference numeral 128 marks axis of symmetry of the main material dispensing head. Axis of symmetry 128 could pass through the center of the nozzle (not shown) or extrusion opening of main material dispensing head 116.

A lever 132 holds satellite material dispensing head 136. Satellite material dispensing head 136 is configured to rotate 360 degrees around axis of symmetry 128 of main material dispensing head 116 and move along the Z-axis. Satellite material dispensing head 136 could also be configured to support linear movement in X and Y direction with the help of a motion system 138. Satellite material dispensing head 136 dispenses or extrudes material identical to the material the main material dispensing head extrudes. In one example, satellite material dispensing head 136 could be configured to extrude a material different in at least one parameter from the material 124 the main material dispensing head 116 extrudes. The parameter could be diameter of the extruded strip, color of the extruded strip and others.

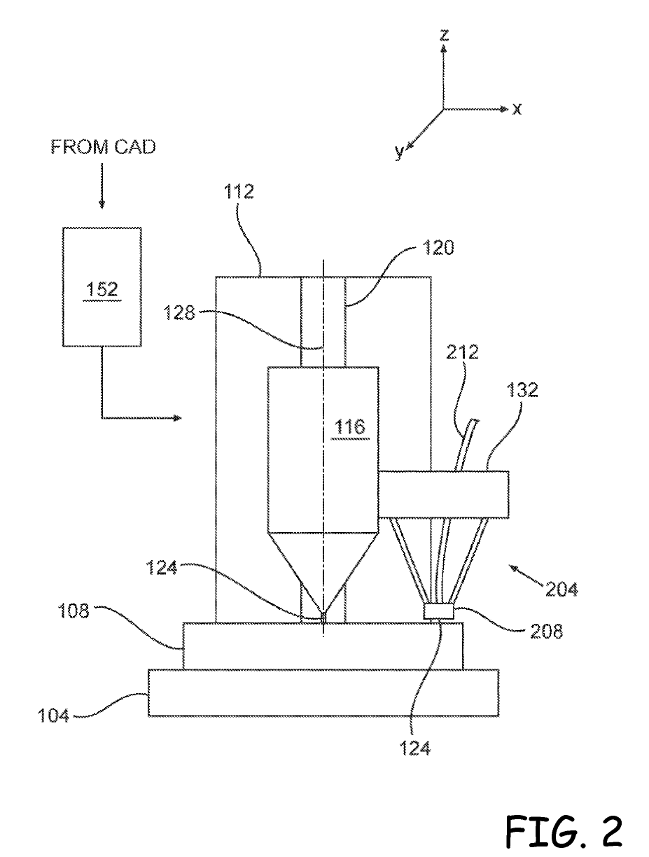

FIG. 2 is an example of another mechanism that supports satellite material dispensing head 136 or a similar head movement. Mechanism 204 is a multilink mechanism similar to the mechanism disclosed in U.S. Pat. No. 4,976,582 and other patents. In some publications mechanism 204 is termed delta mechanism. Material 124 that could be a filament or a gel, is supplied to satellite material dispensing head 208 through a flexible hose 212.

3D object manufacturing machine 100 further includes a motion system and a motion system controller 152 that could be a personal computer (PC) configured to control and move at least the main material dispensing head 116 along a predetermined path. The predetermined path usually corresponds to the layout of the 3D object to be manufactured. The motion system controller 152 is also configured to control and move satellite material dispensing head 136 or 204 along the predetermined path of main material dispensing head 116.

The 3D object to be manufactured could be of regular, like 3D object 108, or arbitrary geometric shape and the predetermined path could include one or more path segments, where the main material dispensing head 116 changes the travel direction. At the predetermined path segments, where main material dispensing head 116 changes the travel direction, the motion system controller 152 is configured to move satellite material dispensing head 136 or 208 in a direction different from the direction main material dispensing head 116 moves.

Motion system controller 152 in addition to motion system control, could also be configured to control the material dispensing or extrusion sequence by the main material dispensing head 116 and satellite material dispensing head 136 and 208 and the path of main material dispensing head 116 and satellite material dispensing heads 136 and 208. Motion system controller 152 could also be configured to receive the 3D object information from a CAD system and interpret it such as to operate the 3D object manufacturing machine to manufacture the 3D object.

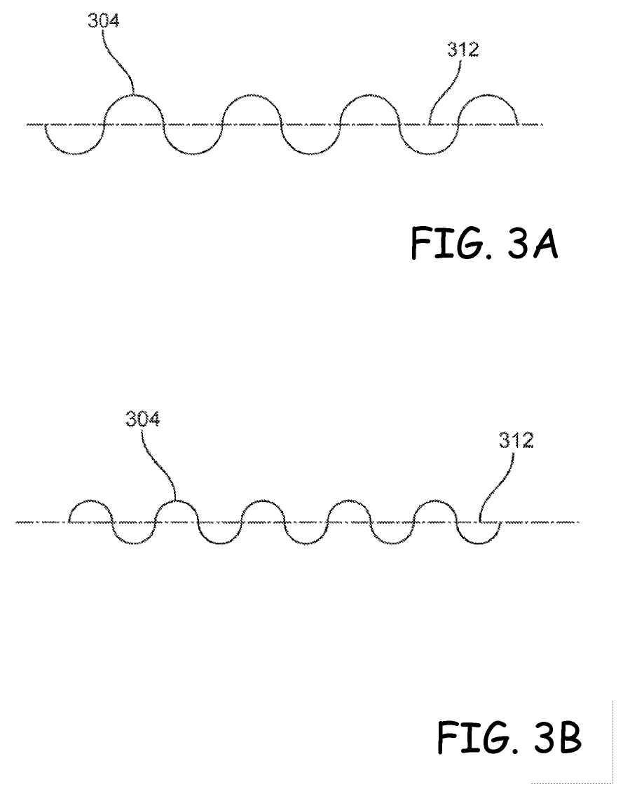

In one example, satellite material dispensing head 136 or 208 moves in an oscillating type movement along and across the main material dispensing head 116 travel direction. The amplitude and frequency of the oscillating type movement of the satellite material dispensing head could be a variable frequency and magnitude amplitude. FIG. 3 is an example of satellite material dispensing head movement pattern. FIG. 3A illustrates a movement pattern with relatively large oscillation amplitude 304 and low frequency and FIG. 3B illustrates a movement pattern with relatively low oscillation amplitude 308 and frequency higher than the frequency of oscillation of FIG. 3A. Reference numeral 312 marks the main material dispensing head 116 travel direction.

For manufacture of a 3D object, controller 152 receives the three-dimensional object information from a CAD system (not shown) and according to the information received generates the 3D object layout. Controller 152 is operating the motion system and moves the main material dispensing head 116 along a pass determined by the 3D object layout. Satellite material dispensing head 136 or 208 is also moving along a path that could be partially overlapping and/or crossing the path of the main material dispensing head.

In one example, both the main 116 and satellite 136 or 208 material dispensing heads are dispensing identical material, although satellite material dispensing heads 136 and 208 could dispense a layer of material different in at least one parameter from the material the main material dispensing head dispenses. The parameter could be the thickness or diameter of the dispensed material, the color of the dispensed material and other parameters.

In another example, the satellite material dispensing head could be an inkjet head that dispenses color ink, including process color ink set to color already dispensed material 124.

In an additional example, satellite material dispensing head could be a Robotic spray dispensing head, such as air brush, that dispenses a two-component material like polyuria foam or polyurethane foam. Examples of such materials could be: “EasyFlo Spray foam FR8 Liquid Plastic” or similar polyurethane foams by any another manufacture. Both, the polyuria foam as well as polyurethane foam, could be dispensed only in the interior of the 3D object, creating a reinforced durable inner shell, without degrading the external appearance of the model.

In a further example, material such as “Styrocoat® Sprayable Plastic Coating” could be applied to the outer side of the shell. Such materials could enhance the strength of the 3D printed model and concurrently improve the external appearance of the 3D model. They could also enhance resistance to damage as well as smooth the layered texture surface. Styrocoat material are available in transparent form and could be dispensed over the color layer or coating, previously deposited, by the inkjet print head. Transparent coating will support and protect the 3D object color appearance.

The satellite material dispensing head movements, at least at segments of the pass determined by the 3D object layout. In the pass segments where the main material dispensing head 116 changes travel direction or pass direction, the satellite material dispensing head 136 could move in a direction different from the direction the main material dispensing head 116 is moving. Satellite material dispensing head could move in a different direction since it possesses capability of a linear movement in X and Y direction. Additionally, satellite material dispensing head could rotate 360 degrees around axis of symmetry 128 of the main material dispensing head 116 and also move in direction of Z axis.

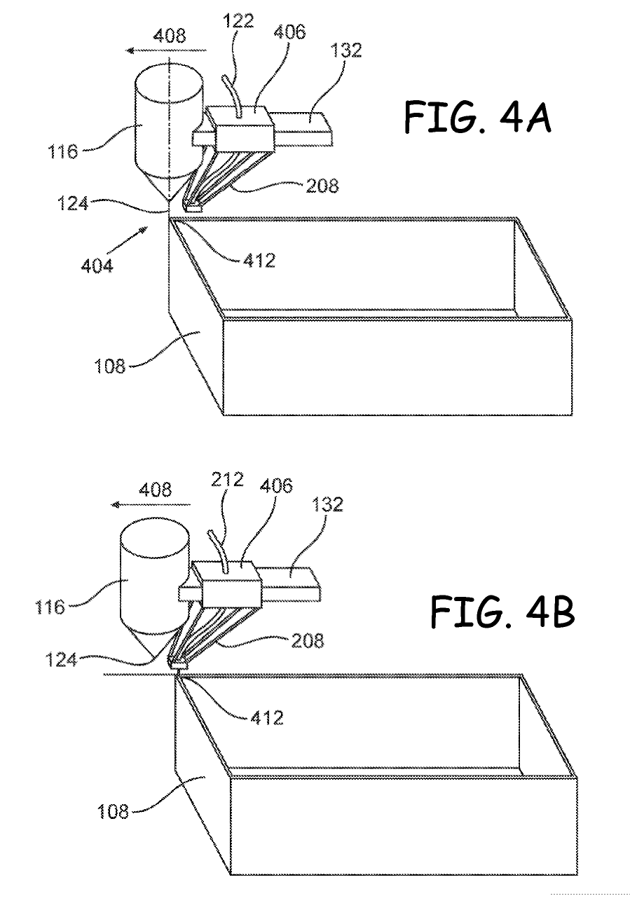

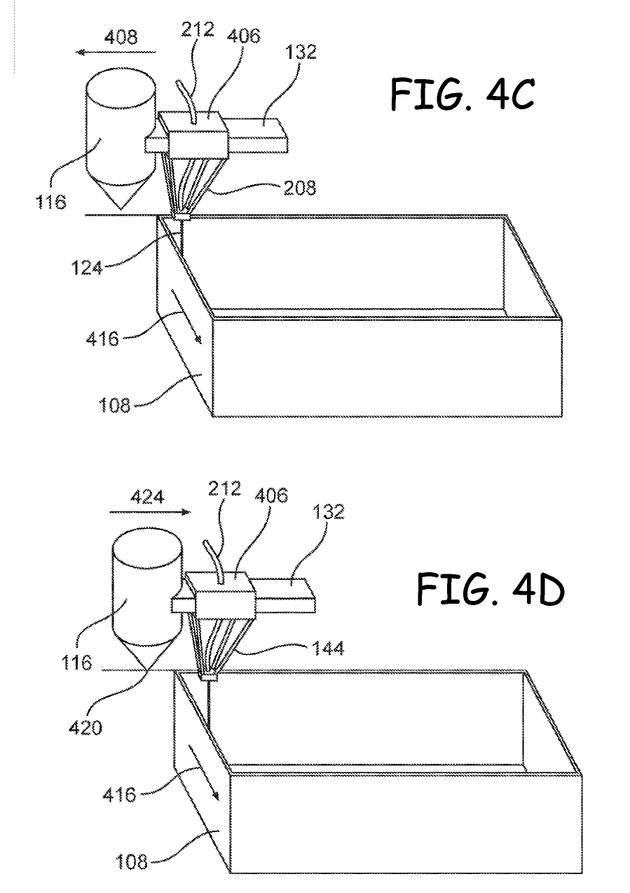

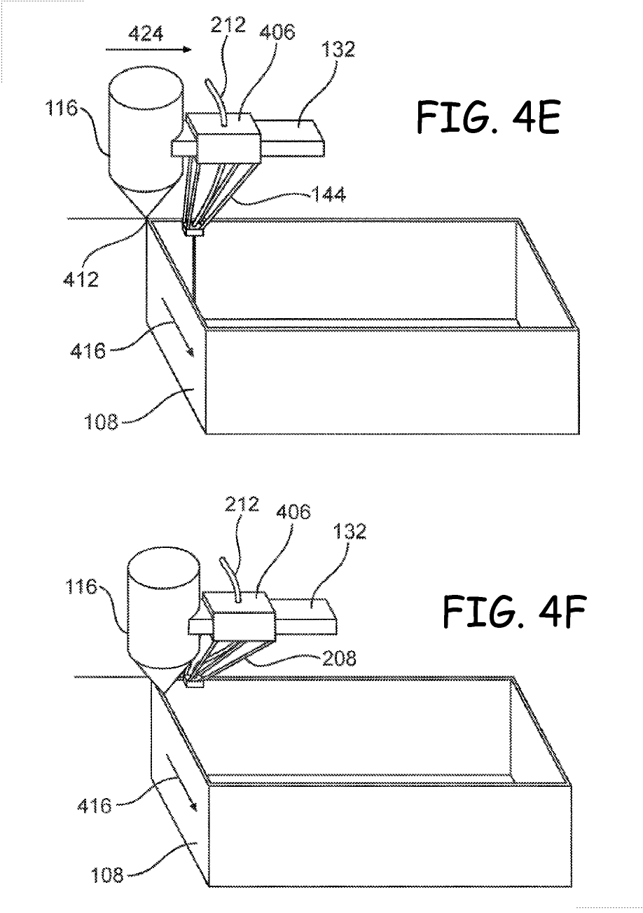

FIG. 4 is an example of satellite material dispensing head movement pattern. FIG. 4 is an example of satellite material dispensing head movement pattern. When main material dispensing head 116 (FIG. 4A) that dispenses material 124, from which 3D object 108 is constructed reaches a segment 404 of 3D object 108 layout where a sharp change of direction (for example, a corner or a sharp bend of the 3D object), the inertia does not allow to stop immediately the heavy main material dispensing head 116. Main material dispensing head 116 continues to travel in the original travel direction (FIG. 4B) as shown by arrow 408. Concurrently movement mechanism 406 of satellite material dispensing head 208 displaces its nozzle to be in position where the dispensed material 124 will be dispensed at the same corner point 412 of 3D object 108.

As main material dispensing head 116 is leaving 3D object 108 layout and moves in the direction indicated by arrow 408, lightweight satellite material dispensing head 208 begins to dispense material 124 and move (FIG. 4C) its nozzle in direction indicated by arrow 416 i.e., in the direction perpendicular to direction 408 of main material dispensing head 116 travel.

FIG. 4D illustrates main material dispensing head 116 that reached its full stop position 420 and begins to return as shown by arrow 424. Movement mechanism 406 of satellite material dispensing head 208 continues to displace its nozzle to dispense material 124 in the direction of arrow 416.

FIG. 4E illustrates main material dispensing head 116 that has returned to corner 412 and both the main material dispensing head and satellite material dispensing head move in the same direction, although the satellite material dispensing head 208 only dispenses material 124. In one example, satellite material dispensing head 208 begins to slow down its movement, although main material dispensing head 116 moves at the original material dispensing speed. FIG. 4F illustrates a position where main material dispensing head 116 and satellite material dispensing head 208 address the same point 430 at which material 124 has to be dispensed. At point 430 satellite material dispensing head 208 discontinues material 124 dispensing and main material dispensing head 116 takes over the material dispensing function.

In a further example, both main material dispensing head 116 and satellite material dispensing head 208 travel together and dispense material 124 over the same segment of 3D object 108. Each head could dispense half of the amount of material 124 to facilitate smooth transition from one material dispensing head to another material dispensing head.

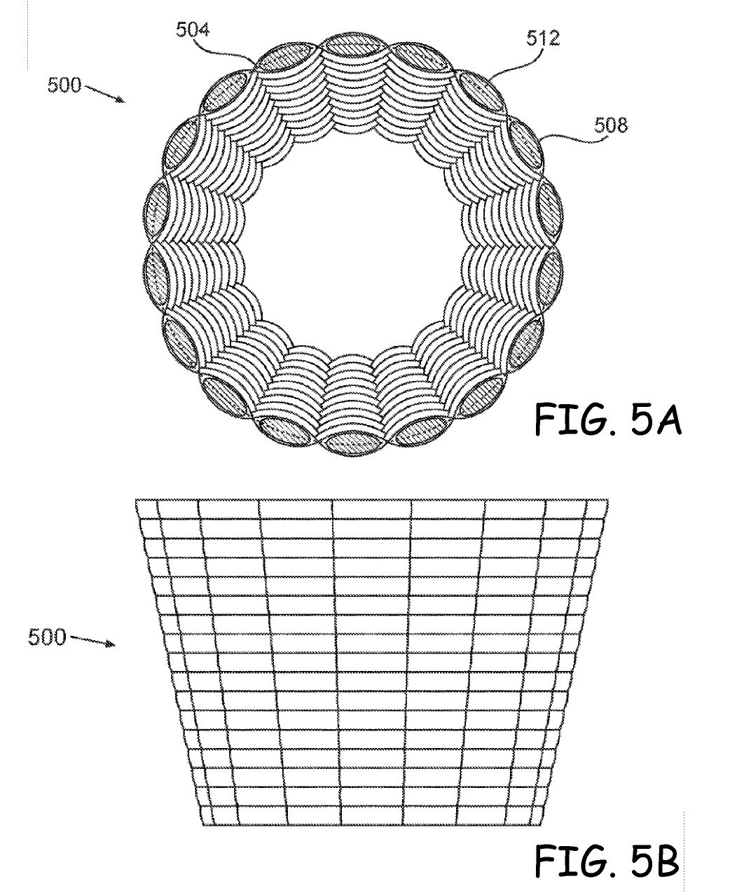

FIG. 5 is an example of a 3D object manufactured by both main and satellite material dispensing heads. The satellite material dispensing head moves in a pattern with oscillating type movement. As illustrated in FIG. 3, the magnitude and frequency of the oscillating type movement of the satellite material dispensing head 208 could change or vary according to the 3D object layout. For example, the magnitude and frequency of the oscillating type movement of the satellite material dispensing head 208 could be large at the 3D object segment that in use will be placed on a support. Different magnitude and frequency of the oscillating type movement of the satellite material dispensing head 208 could be used to print the termination segment of a 3D object. The magnitude and frequency of the oscillating type movement of the satellite material dispensing head 208 could be selected to enhance the mechanical strength of the 3D object to be manufactured. FIG. 5 is an example of a bucket 500 printed using the present method. Line 504 marks travel direction of main material dispensing head 116 and line 508 marks satellite material dispensing head travel direction. Main material dispensing head 116 dispenses material to form columns 512 and satellite material dispensing head 136 or 208 dispenses or extrudes material to form a wavy line 508. Both heads dispense the same material that when solidified forms a strong weaved structure.

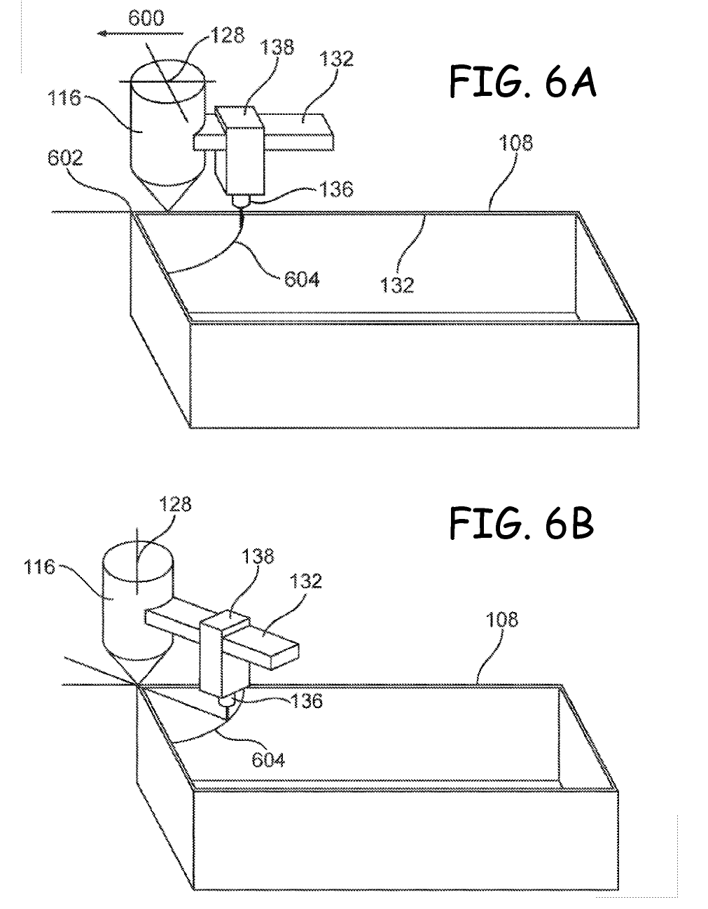

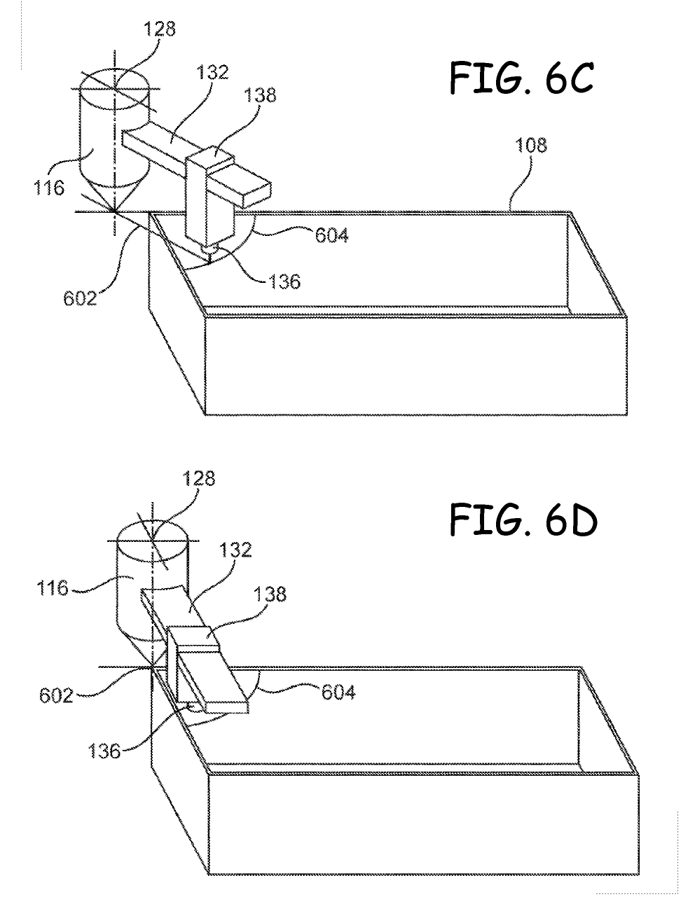

FIG. 6 is an additional example of satellite material dispensing head movement pattern. When main material dispensing head 116 (FIG. 6A) that dispenses material 124, from which 3D object 108 is constructed reaches a segment of 3D object 108 layout where a sharp change of direction (for example, a corner 602 or a sharp bend of the 3D object), the strength of which should be enhanced, inertia does not allow to stop immediately the heavy main material dispensing head 116. Main material dispensing head 116 continues to travel in the original direction as shown by arrow 600. Concurrently motion mechanism 138 of satellite material dispensing head 136 rotates head 136 displaces its nozzle along lever 132 to be in position where the dispensed material 124 will be dispensed at a proper location of segment 604.

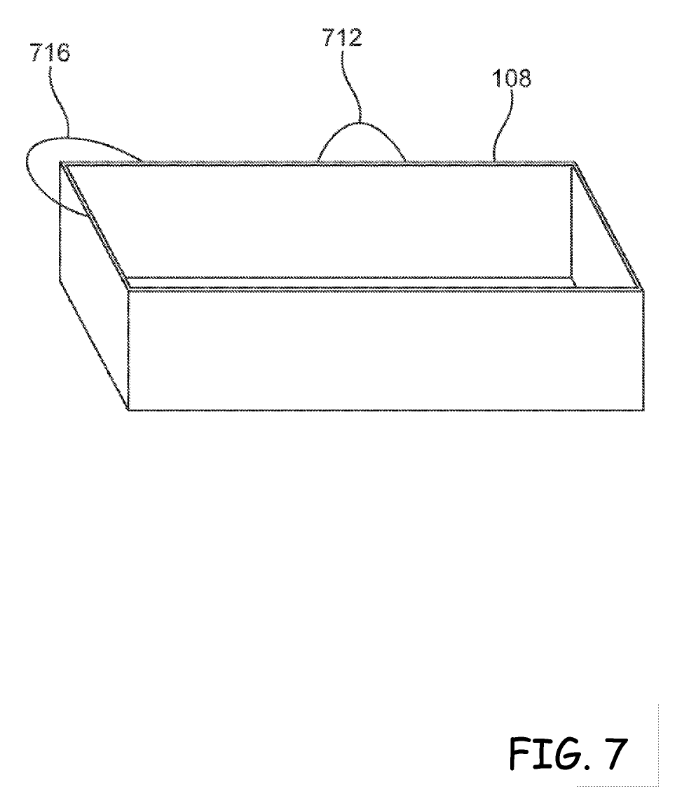

The process continues until satellite material dispensing head 136 accomplishes manufacture of segment 704 that enhances the strength of 3D object 108. As illustrated in FIG. 7 external segments 712 or 716 could be manufactured in a similar way.

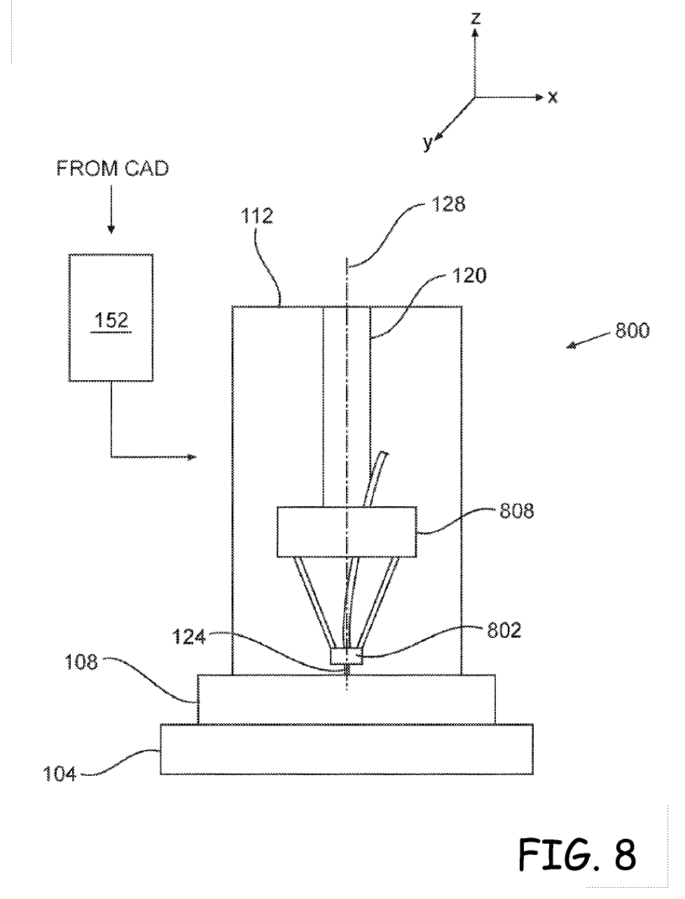

Reference is made to FIG. 8 which is a schematic illustration of a 3D object manufacturing machine of a 3D manufacturing machine according to still another example. Machine 800 includes a support 104 configured to support a 3D object 108 to be manufactured. Support 104 could be a static support and also it could move 3D object along the X and Y axes. In some examples, support 104 could optionally move in the direction of Z-axis. Column 112 holds a main material dispensing head 802 and guides 120 on which main material dispensing head 802 could move in the direction of Z-axis.

The heavy main material dispensing head has been replaced by a lightweight head 802 suspended on a multilink mechanism 804 similar to multilink mechanism 204. Multilink mechanism 804 is mounted or attached to a carrier 808 configured to move main material dispensing head 802 on a distance exceeding the span of multilink mechanism 804. Main material dispensing head 802 is a lightweight head.

Carrier 808 moves main material dispensing head 802 along a predetermined path. The predetermined path usually corresponds to the layout of the 3D object to be manufactured. The 3D object to be manufactured could be of regular, like 3D object 108, or arbitrary geometric shape and the predetermined path could include one or more path segments, where the main material dispensing head 802 changes the travel direction. Since the main material dispensing head 802 is a lightweight head the sharp change of direction (for example, a corner or a sharp bend of the 3D object, FIG. 4), there is no need to overcome inertia and main material dispensing head 802 could easy change the travel direction.

Additionally, main material dispensing head 802 is mounted on carrier 808 and a combination of movements similar to the movements described in relation to FIG. 4 is possible, although the concurrent movement of carrier 808 and main material dispensing head 802 is short and main material dispensing head 802 continuously dispense material 124 from which 3D object is manufactured.

The use of the satellite material dispensing head provides a distinct advantage over other 3D objects manufacturing machines by using for material dispensing the time it takes to the main material dispensing head to change travel direction.

Another advantage secured by the use of the satellite material dispensing head invention is that it could dispense material different from the material dispensed by the main material dispensing head in at least one parameter. It could also be used to dispense color, including process color.

The disclosed 3D objects manufacturing machine is expected to provide an increase of the machine throughput, use of a number of materials and addition of color to the 3D object to be manufactured.

What is claimed is:

1. A method for three-dimensional object manufacture comprising:
providing a 3D object manufacturing machine equipped with a main and satellite material dispensing heads;
moving the main material dispensing head along a pass determined by a 3D object layout; and
moving the satellite material dispensing head along a pass at least partially overlapping the pass of the main material dispensing head;
operating the satellite material dispensing head at least at segments of the pass determined by the 3D object layout where the main material dispensing head changes travel direction the pass direction.

2. The method according to claim 1, wherein the main material dispensing head and the satellite material dispensing head are extruding identical material.

3. The method according to claim 1, wherein moving the satellite material dispensing head along the pass at least partially overlapping the pass of the main material dispensing head includes an oscillating type movement of the satellite material dispensing head.

4. The method according to claim 1, wherein operating the satellite material dispensing head at least in segments of the pass determined by the 3D object layout where the main material dispensing head changes travel direction the pass direction.

5. The method according to claim 1, wherein also rotating the satellite material dispensing head rotates 360 degrees around axis of symmetry of the main material dispensing head.

6. The method according to claim 1, wherein also moving the satellite material dispensing head in a linear movement in X and Y direction.

7. The method according to claim 1, wherein employing the satellite material dispensing head to extrude material identical to the material the main material dispensing head extrudes.

8. The method according to claim 1, wherein employing the satellite material dispensing head to extrude material different in at least one parameter from the material the main material dispensing head extrudes.

9. The method according to claim 1, wherein moving the satellite material dispensing head moves in an oscillating type movement along and across the main material dispensing head travel direction.

10. The method according to claim 9, wherein changing magnitude and frequency of the oscillating type movement of the satellite material dispensing head according to the 3D object layout.

11. The method according to claim 9, wherein also moving the satellite material dispensing head in direction of Z axis.

12. The method according to claim 1, wherein employing the main material dispensing head and satellite material dispensing head to extrude the material through a nozzle.

13. The method according to claim 1 further comprising a controller configured to control at least the motion system, material extrusion sequence by the main material dispensing head and satellite material dispensing head and path of main material dispensing head and satellite material dispensing head.

14. The method according to claim 1, wherein the main material dispensing head moves in an oscillating type movement along and across the direction of the 3D object layout.

15. A machine for three-dimensional object manufacture comprising:
a support configured to support a 3D object to be manufactured;
a main material dispensing head and a satellite material dispensing head;
a motion system configured to move at least the main material dispensing head along a predetermined path and wherein the predetermined path includes at least one segment where the main material dispensing head changes travel direction; and wherein the motion system is configured to move the satellite material dispensing head along the predetermined path of the main material dispensing and wherein at a segment where the main material dispensing head changes travel direction the satellite material dispensing head moves in a direction different from the direction the main material dispensing head moves.

16. The machine according to claim 15, wherein the satellite material dispensing head is further configured to rotate 360 degrees around axis of symmetry of the main material dispensing head.

17. The machine according to claim 16, wherein the satellite material dispensing head is further configured to support linear movement in X and Y direction.

18. The machine according to claim 15, wherein the satellite material dispensing head extrudes material identical to the material the main material dispensing head extrudes.

19. The machine according to claim 15, wherein the satellite material dispensing head extrudes a material different in at least one parameter from the material the main material dispensing head extrudes.

20. The machine according to claim 15, wherein the satellite material dispensing head moves in an oscillating type movement along and across the main material dispensing head travel direction.

21. The machine according to claim 20, wherein amplitude of the oscillating type movement of the satellite material dispensing head is a variable magnitude and frequency amplitude.

22. The machine according to claim 21, wherein the satellite material dispensing head is configured to move in direction of Z axis.

23. The machine according to claim 15, wherein the main material dispensing head and a satellite material dispensing head are material extrusion heads.

24. The machine according to claim 23, wherein the main material dispensing head extrudes the material through a nozzle.

25. The machine according to claim 15 wherein the main material dispensing head is a multilink mechanism attached to a carrier configured to move the main material dispensing head on a distance exceeding span of the multilink mechanism.

26. The machine according to claim 15 further comprising a controller configured to control at least the motion system, material extrusion sequence by the main material dispensing head and satellite material dispensing head and path of the main material dispensing head and satellite material dispensing head.

27. A machine for three-dimensional object manufacture comprising:
a support configured to support a 3D object to be manufactured;
a main material dispensing head and a satellite material dispensing head;
a motion system configured to move at least the main material dispensing head along a predetermined path and wherein the predetermined path includes at least one segment where the main material dispensing head changes travel direction; and wherein the motion system is configured to move the satellite material dispensing head in an oscillating movement along the predetermined path of the main material dispensing head.

28. The machine according to claim 27 wherein at a segment where the main material dispensing head changes travel direction the satellite material dispensing head moves in a direction different from the direction the main material dispensing head moves.
